(19) United States
(12) Patent Application Publication
(10) Pub. No.: US 2006/0138867 A1
(43) Pub. Date: Jun. 29, 2006

(54) Modular AC power supply system with fault bypass and method of switching output modes

(76) Inventors: Shou-Long Tian, Baoan Shenzhen (CN); Gang Liu, Baoan Shenzhen (CN)

Correspondence Address: DENNISON, SCHULTZ, DOUGHERTY & MACDONALD, 1727 KING STREET, SUITE 105, ALEXANDRIA, VA, 22314, US

(21) Appl. No.: 11/362,131

(22) Filed: Feb. 27, 2006

Related U.S. Application Data
(62) Division of application No. 10/639,489, filed on Aug. 13, 2003.

(51) Int. Cl. H02J 7/00; H02J 9/00

(52) U.S. Cl. 307/65; 307/66

(57) ABSTRACT

A modular AC power supply system with fault bypass and the method of switching output modes is provided. The system architecture allows a plurality of uninterruptible power supply (UPS) modules connected in parallel to share the loads and tripped for fail independently. A virtual control center is automatically installed in one of the UPS modules at system initialization, used for controlling all UPS modules connected over the UPS network. When a disorder is detected in any UPS module, the virtual control center first collects the operation data from other parallel UPS modules through a high speed communication line, and then decides to send a command to the failing module to trip and shutdown, or to send a command to all parallel UPS modules to switch to the bypass mode through a high speed communication line. The system also employs a low priority interrupt with the falling edge of sync clocks to enhance the overall system reliability and the usage of system resources.

This is a divisional application of an U.S. application Ser. No. 10/639,489, filed on Aug. 13, 2003, which is now pending.

### BACKGROUND OF THE INVENTION

1. Field of the Invention

The present invention relates to a modular power supply system with bypass and the method of switching output modes, in particular to an AC power supply system that is capable of providing fault-tolerant protection for critical loads or loads requiring high power output.

2. Description of Related Arts

Computers and networking have become essential tools for enhancing the economic and technological development in many countries. To keep the operation of computers and networks working in normal condition, there has to be a continuous supply of electrical power. Even a brief power interrupt could cause massive loss of data for data processing equipment and breakdown of data communication systems. Companies and individual users alike realize the need of maintaining a reliable source of electricity and see the benefits of installing an uninterruptible power supply, to protect their installation and the operation results therefrom. Therefore, the demand for uninterruptible power supply is increasing steadily.

The uninterruptible power supply (UPS) systems can be generally classified as on-line and off-line types. For off-line UPS, power input is normally set in a main-line mode with the power input directly connected to the main-line through a bypass, and only when a power break occurs over the main-line, the power supply is switched to a battery output mode drawing the power from a battery through an inverter. The design of the off-line UPS, though simple, does not provide power regulation for the line input, and longer time is needed for detecting any power break over the main-line and subsequently switching to the battery output mode.

For the on-line UPS, the AC power output is always fed through an inverter with signal filtering, in both the main-line and battery output modes. Since on-line UPS does not need to switch the output path between the bypass and inverter, the mode switching process can be effected with shorter time, whereas the switching usually takes about 10 ms for off-line UPS. Since the on-line UPS can offer a more reliable power supply, the demand for this type of UPS is increasing steadily.

The architecture of an on-line UPS comprises an AC/DC converter, a DC/DC converter, a DC/AC inverter, a bypass circuit and a charger. In a normal condition, the power input is fed through the AC/DC converter to change from AC to DC, and then further fed through the DC/AC inverter to generate AC power output. When the UPS is down or experience overloading, the UPS will be instantly switched to the bypass mode for direct connection of the load and the main power, such that continuous power supply can be maintained without interruption. The battery and the main-line can be connected in parallel as the power input for the DC/AC inverter, and the voltage output of the battery through a DC/DC converter can be designed to be lower than that from the main-line through the AC/DC converter. In the normal supply conditions, the power supply comes from the main-line, but when the main power is not available, the UPS will be automatically switched to the battery output mode, such that the current from the battery will pass through the DC/DC converter boosting the DC output voltage, and then further through an inverter to AC output for the load. Besides, the UPS has an additional function of protecting the electrical equipment from high voltage spikes during lightning strikes.

Over the years, the storage capacity and reliability of UPS has upgraded considerably. New power systems have taken care of scalability and flexibility in their designs.

To fill the increasing demands and make the power supply more reliable, a plurality of UPS modules is connected in parallel for parallel operation. When a UPS module is down, the control system should be able to isolate the failing UPS module, without affecting other parallel UPS modules still supplying the load. This fault tolerant design provides a more reliable power source for critical loads or loads with high power requirements. Furthermore, with modular UPS the power supply system can be easily upgraded or maintained operated if required, simply by increasing the number of UPS modules or making adjustments to fill different needs of power users.

For a standalone UPS, in case of overloading or equipment failure, the UPS is switched to the bypass mode to prevent power interruption to the load. If the fault occurs on one of the UPS modules in a conventional modular power supply system, the system cannot isolate a single failing UPS module from other parallel UPS, instead it will order all UPS modules to switch to the bypass mode as a safety measure.

There is another problem with the mutual interference, which may cause some UPSs to switch erroneously, or fail to switch at all, resulting in the anomalous parallel connection between the inverters and the main-line. This could lead to a situation of system breakdown. It is therefore necessary to find a way to enhance the system reliability in synchronous switching to or back from bypass mode. In addition, it is necessary to lower the production costs with simple circuit implementation.

In one prior art, U.S. Pat. No. 6,292,379 B1, a method of synchronous switching of UPS modules to bypass is proposed. Each UPS module paralleled in the system is composed of an inverter, a bypass circuit and a controller. All UPS modules are interconnected by a high-speed communication bus and a logic state control line forming a network. When any module in the system is about to switch to the bypass mode, the module first has to gain control of a sync-line, an extra synchronization control line, by posting a request onto the network through the high speed communication bus. After obtaining the permission the module notifies other modules of the impending switch to the bypass mode, and then sends a toggle signal over the sync-line to generate a top priority interrupt forcing all modules to be switched to the bypass mode simultaneously.

This prior art has demonstrated the feasibility of switching all UPS modules in the modular power supply system to the bypass mode simultaneously, just like a standalone UPS, in case of overloading or equipment failure. Although this technique can enhance the reliability of parallel UPS modules, it only provides a fundamental approach to the issue at hand.

The prior art has not considered the following issues:

(1) Sending a toggle signal over the extra sync-line for system synchronization can lead to false switching of UPS due to noise. As a result, the UPS modules in the modular power supply system may be operating in different modes, leading to the anomalous situation that the inverters parallel to the main-line voltage.

(2) When the toggle signal is sent over the sync-line to all UPS modules using a top priority interrupt, the normal operation of the CPU is paused by the interrupt signal, holding up the system resources for the sole purpose of switching a UPS module to the bypass mode. This method may be too costly for the system, as it is only necessary to isolate a failing UPS module in one of the rare situations when the operation of the UPS module is at fault, resulting in substantial waste of CPU resources and extra costs for the synchronization line.

(3) The switching of all UPS modules to the bypass mode at one time just because of the failure of a single unit in the system is not reasonable and undesirable for critical loads or loads with high power requirement. For example, there are three UPS modules with a total capacity of 3000 VA sharing a load with the power requirement of 1000 VA. If one of the UPS modules is down, according to the logic of the prior art, all three UPS modules will be switched to the bypass mode simultaneously. If the main-line is not stable at that time, the operation of the load will be in jeopardy. Design on new UPSs allows the power out to be fed through the inverter in all possible conditions to enhance the overall reliability of the power supply, and only resorts to switch to the bypass mode as a last option.

(4) Possible damage from electric arcing during the switching action of the output relay: when a UPS is switched to the bypass mode, it is necessary to assure that the output relay toggles when the output voltage is at the zero crossing point, otherwise arcing is produced during the switching of the relay, which may force the relay to be reset to normal-closed or normal-open unexpectedly. In parallel modular power supply systems, any damage to the output relay in the module will result in the inverter and the main-line anomalously connected in parallel leading to a system breakdown.

The present invention has paid due consideration to the above mentioned elements to make the new modular power supply system more reliable and more efficient in using CPU resources, such that when a UPS module is down or overloaded, the system is able to isolate the failing UPS to prevent it from affecting other parallel UPS modules.

### SUMMARY OF THE INVENTION

The main object of the present invention is to provide a method for managing the modular power supply system whereby any UPS module at fault can be isolated from other UPS modules in parallel operation. The mode switching in the present invention only employs a low order interrupt that could avoid halting of the normal operation for other UPS modules. The present invention thus provides enhanced system reliability and efficient control of parallel UPS operation.

To accomplish the above object each UPS module in the modular power supply system is provided with identical control logic for parallel processing and participation in an arbitration scheme to create a virtual control center (VCC) which is designed to control the operation of all parallel UPS modules.

Each UPS module is connected by a common high-speed communication line (HSCL) for inter-unit communication. Each UPS module is also connected by a common sync-clock-line (SCL), a control line originally embedded in the modular power supply system, for controlling the output phase from all inverters and the synchronous switching to the bypass output.

Each UPS module participates in an arbitration scheme over the UPS network through the HSCL to compete for possession of the VCC when the modular power supply system is initialized. When the requesting UPS module is granted possession of the VCC, all other UPS modules will send in their operating data for the system to determine whether any UPS module needs to be isolated from other parallel UPS modules.

If, for some reason, the original UPS module possessing the VCC disappears from the UPS network, it will automatically relinquish the VCC to a new UPS module that begins to assume the VCC in place of the original UPS module that may be down.

The above mentioned VCC takes control of the sync-clock-line, through which the VCC continuously sends out sync clock signals to synchronize the operation of all UPS modules connected over the UPS network. The control signals output by the VCC are used to synchronize the power output of all parallel UPS modules, such that the output voltage from each inverter (InvVolt) should correspond with the phase angle and frequency as the sync clocks when the switch command is issued by the VCC. Furthermore, the zero crossing points of the InvVolt should also correspond with the rising edge and falling edge of the sync clocks. The above-mentioned sync-clock-line is embedded in the system hardware for synchronizing the output voltage from all UPS modules connected over the UPS network. The embedded sync-clock-line is able to minimize the risks of mutual interference, as compared with the prior art in which an extra sync-line is used exclusively for controlling the synchronous switching to the bypass modes, thus increasing the risks of signal conflicts.

The synchronous switching of all UPS modules should be effected by an interrupt at the rising/falling edge of the sync clock, which allows all parallel UPS modules to receive the above signal at the same time for a synchronized switching between the inverter output and the bypass output.

A typical UPS module in accordance with the present invention comprises an AC/DC converter, a DC/DC converter, a charger, a bypass circuit and a DC/AC inverter.

The bypass circuit is formed by two stage relays, such that the total capacity of the bypass output of the system is the sum of the individual relay output of all parallel UPS modules. By means of the two-stage relay mechanism to isolate the failing UPS, the system of parallel UPS modules can be managed efficiently without affecting other parallel UPS modules.

The features and structure of the present invention will be more clearly understood when taken in conjunction with the accompanying drawings.

### BRIEF DESCRIPTION OF THE DRAWINGS

FIG. 1 is a block diagram of the architecture of the modular power supply system in accordance with the invention;

FIG. 2 is a schematic of the control circuits in a typical UPS module;

FIG. 3 is the logical flow of the operation initiated by a VCC for synchronous switching of all UPSs to the bypass mode;

FIG. 4 shows the signal waveforms of the output voltage signal from an inverter and the sync clocks when a switch command is issued by the VCC, both are in sync having the same phase angle and frequency;

FIG. 5 is the logical flow of an interrupt subroutine initiated by the non-VCC for synchronizing the switching from the inverter output to the bypass output;

FIG. 6 is the logical flow of operation initiated by the VCC for all UPSs to be switched back from the bypass output to the inverter output;

FIG. 7 is the logical flow of an interrupt subroutine initiated by the non-VCC for synchronizing the synchronous switching back from the bypass output back to the inverter output;

FIG. 8 is the interrupt subroutine executed by non-VCC at the falling edge of the sync clock.

### DETAILED DESCRIPTION OF THE PREFERRED EMBODIMENT

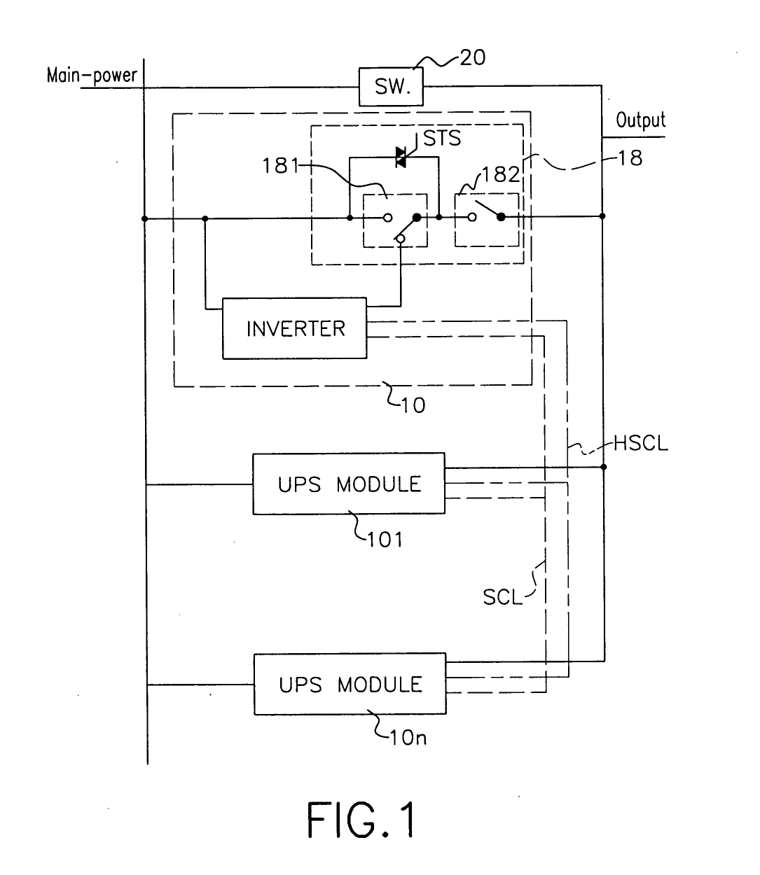

The present invention provides a method for managing a modular power supply system consisting of a plurality of uninterruptible power supply (UPS) modules (10) (101˜10n) connected in parallel. As shown in FIG. 1, the input terminal of each UPS module (10) (101˜10n) is connected in parallel to a common system input or the main power, and the output terminal of each UPS module (10) (101˜10n) is also connected in parallel to an AC output bus. The input and output of the modular power supply system (10) are connected across by a manual-bypass switch (20) used for tuning and system installation. The manual-bypass switch (20) has an output capacity that should be equal to or larger than the maximum capacity of the system, and the manual-bypass switch (20) should be set to normal-open in normal condition.

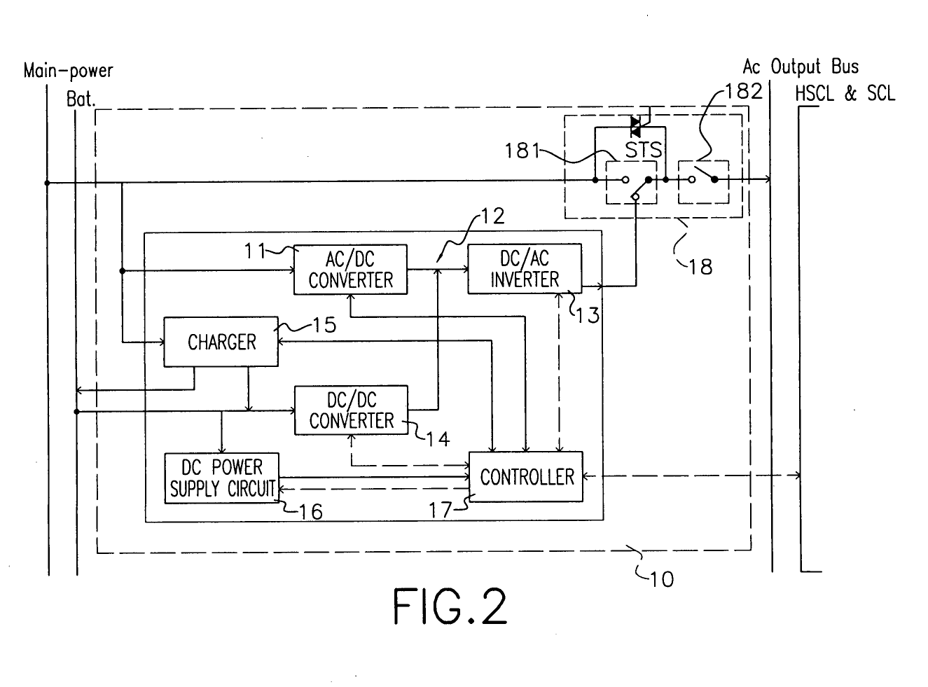

The structure of each UPS module (10) includes (shown in FIG. 2):

an AC/DC converter (11) coupled to the output of an input filter for converting the line AC to DC;

a DC bus (12) acting as the internal power bus;

a DC/AC inverter (13) coupled to the output of the AC/DC converter (11) through the DC bus (12) for converting DC power to AC output;

a DC/DC converter (14) with the input directly connected to the DC power source, and the output to the DC bus (12) for boosting the DC to high voltage;

a charger (15) coupled to the AC input;

a DC power supply (16) for providing a continuous supply of electrical power to the local UPS module (10);

a controller (17) built in with independent processing capability and the ability to accept the role of a virtual control center (VCC) through an arbitration over the high speed communication line (HSCL), and the controller (17) is connected by the DC/AC inverter (13), AC/DC converter (11), and DC/DC converter (14) for controlling the operation of the local UPS module (10); and

a bypass circuit (18) formed by a first-level relay (181) and a second-level relay (182), connecting across the input and output of each UPS module (10).

In the two-stage relay circuit, the first-level relay (181) circuit is implemented by a two-position relay, and the second-level relay (182) by a single-position relay. The second-level relay (182) is used for making or breaking the connection between the power output from the UPS module and the AC output bus. If the second-level relay (182) is closed, the power output of the UPS module (10) can be delivered to the parallel AC Output Bus. The first-level relay (181) is used for mode switching. When the UPS module is switched to the bypass mode, the first-level relay (181) will be toggled to the normal-open position, allowing the power from the main-line to be delivered to the parallel AC Output Bus through the closed second-level relay (182). When the UPS module is switched to the inverter mode, the first-level relay (181) will be toggled to normal-close position, and then the output of the DC/AC inverter (13) will be connected to the parallel AC Output Bus through the closed second-level relay (182). A STS switch is also connected across the first-level relay (181) for protecting the load from power interruption during the mode switching process.

The use of the two-stage relays (181) (182) enables the introduction of intelligent management on the modular power supply system. For example, a number of UPS modules (10) (101˜10n) are connected in parallel, and one of the modules is at fault. It is not necessary to switch all the UPS modules (10) (101˜10n) to the bypass mode, but only the failing UPS module needs to be isolated by tripping the second-level relay (182). This allows the other UPS modules (10) (101˜10n) to run in parallel unaffected by the action taken by the VCC to disconnect the failing UPS. If the UPS module (10) only has the first-level relay (181) without the second-level relay (182), and the first-level relay (181) is switched to the normal-open position, then the UPS module directly enters the bypass mode with two possibilities. In the first case, the system might cause other inverters to be paralleled to the main-line voltage; or in the second case, that some of the other UPS modules might be erroneously set to charge a bypassed UPS module while other UPS modules are disconnected from the main-line. Both cases would be undesirable from the system point of view.

Since the controllers (17) of all UPS modules (10) (101˜10n) are connected in parallel to the high speed communication line (HSCL) and the sync-clock-line (SCL), the controller (17) in each module (10) (101˜10n) is able to communicate with the counterparts in other parallel UPS modules (10) (101˜10n) through the HSCL, and each controller (17) has the independent processing capability and the ability to accept the role of the virtual control center (VCC) by participating in an arbitration over the HSCL. In the intelligent management model, the virtual control center (VCC) created in one of the parallel UPS modules (10) acts as the hub in controlling the operation of the modular power supply system. At any given time only one UPS module among all parallel UPS modules (10) (101˜10n) takes possession of the VCC, that means there is only one VCC in the whole network of UPS modules connected in whole system. If, for some reason, the original UPS module in possession of the VCC disappears from the UPS network, then another UPS module (10) (101˜10n) will be elected to be VCC among the peers by the same arbitration process that was used to select the first UPS module for taking over the role of the VCC.

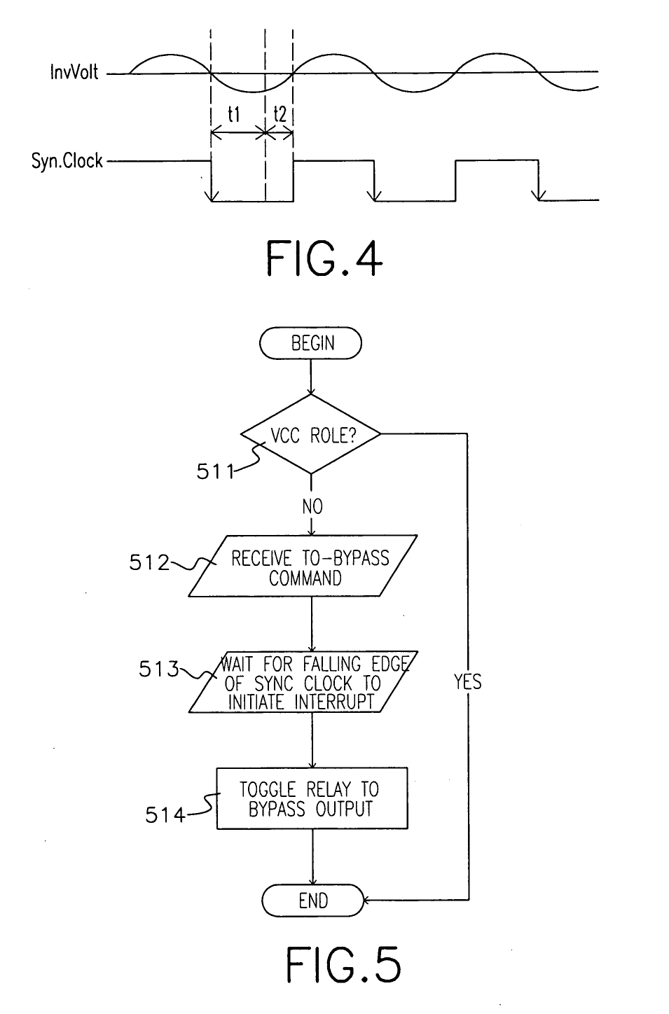

The VCC has full control over the sync-clock-line (SCL), and sends out square wave sync clocks over the SCL continuously, as shown in FIG. 4. The sync clocks issued by the VCC will be in sync with the inverter output voltage (InvVolt) having the same phase angle and frequency as the sync clock. Furthermore, the zero crossing of the inverter output voltage (InvVolt) of the UPS module is controlled by the controller (17) to follow the rising edge and falling edge of the sync clocks. In the present embodiment, the falling edge is also selected for triggering the system interrupt without extra sync-line as in the prior art.

The VCC has full control over the SCL by sending out square wave sync clocks, as shown in FIG. 4. The output voltage from each inverter (InvVolt) should correspond with the phase angle and frequency of the sync clocks when the switch command is issued by the VCC. Furthermore, the zero crossing points of the InvVolt should also correspond with the rising edge and falling edge of the sync clocks. All the UPS modules (10) (101˜10n) connected over the UPS network are able to detect the falling edge of the sync clock and use it to produce a falling edge interrupt. With due consideration of any signal delay, all UPS modules (10) (101˜10n) connected in parallel will be able to generate a falling edge interrupt at the same time, as all modules (10) (101˜10n) experience identical moments of zero crossing of the output voltage. It is therefore to effect the synchronized switching from the inverter output to the bypass output with a system interrupt at the falling edge of the sync clock. The other advantage of using the square wave sync clock is that noise interference, if any, can be easily filtered out by software and hardware to prevent false switching of the modules (10) (101˜10n).

In FIG. 8, when an interrupt occurs at the falling edge of the sync clock, the system has to determine whether the interrupt is caused by noise (811). If the system determines that the interrupt is not caused by noise, then the system proceeds to the interrupt process (812).

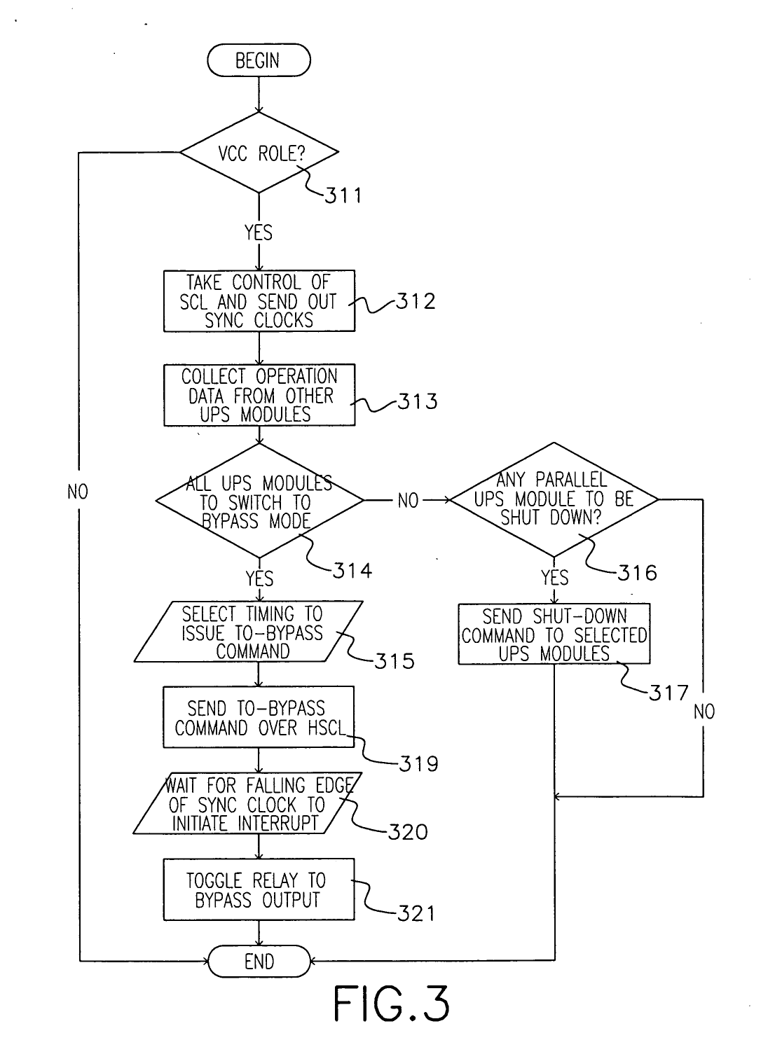

According to the present invention, the VCC acts as the hub in the implementation of intelligent management over the modular power supply system. After taking control of the sync-clock-line (SCL) (311), as shown in FIG. 3, the VCC continuously sends out sync clock over SCL (312), and then collects the operation data from all parallel UPS modules (313) through the HSCL, from which the VCC determines whether it is necessary for all UPS modules to switch to the bypass mode (314). The basic criteria for making the to-bypass switch are that the total power requirement of the load should be smaller than the total capacity of the UPS modules. If the criteria are met, it is not necessary to switch the whole system to the bypass mode; if not, then all modules need to be switched to the bypass mode at once.

When the VCC determines that it is necessary to switch the whole system to the bypass mode, it needs to select an appropriate timing to send the to-bypass command to all UPS modules for the switching (315). The condition for issuing the command is to assure that all UPS modules (10) (101˜10n) are operating in synchronization. To accomplish the synchronization, it is necessary to have all the UPS modules (10) (101˜10n) receive the VCC command before the falling edge of the sync clock, with due consideration for the propagation delay for the signal and the interrupt. In the present invention, as shown in FIG. 4, the VCC command is always issued in a predetermined time t1, such that all UPS modules have the time t2 to cover the propagation delay for the signal and the interrupt. After the VCC sends out the to-bypass command ordering the UPS module to switch to the bypass mode (319), all the UPS modules (10) (101˜10n) will wait for the falling edge of the sync clock for the interrupt (320). After the interrupt takes place, the UPS module sends a toggle signal to the output relay (18) to switch to the bypass (321).

From the point of the UPS modules, all the parallel UPS modules (10) (101˜10n) will be able to receive the switch command and subsequently synchronize their switching operations through the HSCL and SCL. When a non-VCC UPS module (10) receives the to-bypass command (512), the module (10) waits for the falling edge of the sync clock that will appear over the sync-clock-line (513). After the interrupt is effected, the UPS module (10) will send a toggle signal to the output relay for switching to the bypass (514). The above procedures describe the synchronized operation of all UPS modules (10) (101˜10n) for switching to the bypass mode.

Still referring to FIG. 3, when the VCC determines that it is not necessary to switch all modules (10) (101˜10n) to the bypass mode (314), it proceeds to check whether one or more UPS (10) (101˜10n) needs to be disconnected (316). If the condition is met, the VCC sends out the shutdown command to shut down the selected UPS module (317). Then the selected UPS module will trip its second-level relay (182) and shutdown itself after received the shutdown command from VCC.

When the system decides to toggle the output relay for making the mode switch, it is necessary to follow the standard operating procedures in order to prevent power break to the load and protect the output relay. In the preferred embodiment, a STS switch is used for this purpose.

When the selected UPS module (10) toggles the first-level relay (181), as shown in FIG. 1, the STS switch has to be closed at the same time, connecting the output directly with the main-line. After the first-level relay (181) is switched to the bypass output, then the STS switch is opened again, thus switching the power output path from the inverter to the bypass circuit. From FIG. 4, when the first-level relay (181) is toggled at the zero crossing of the AC output, since the output voltage coincides with the falling edge of the sync clock having the same phase angle, thus avoiding damage to the output relay from electric arcing.

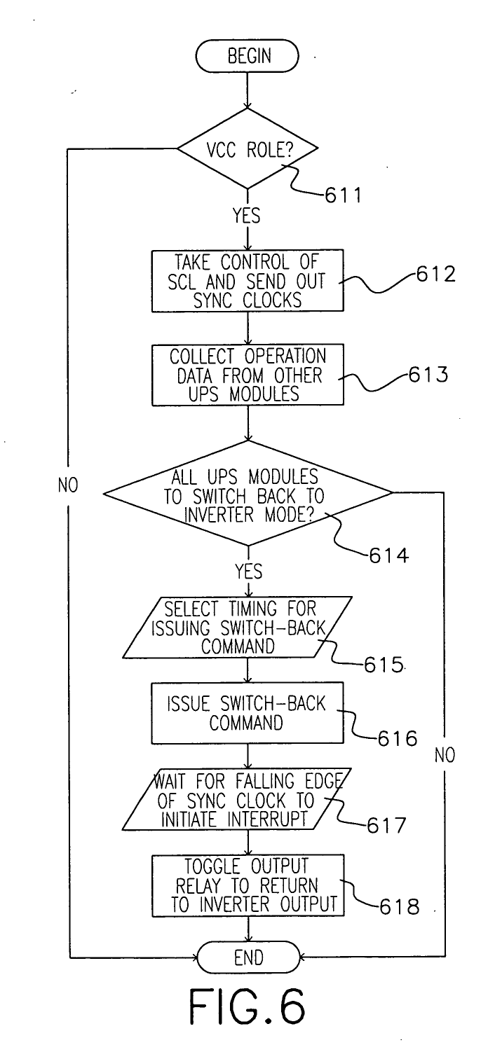

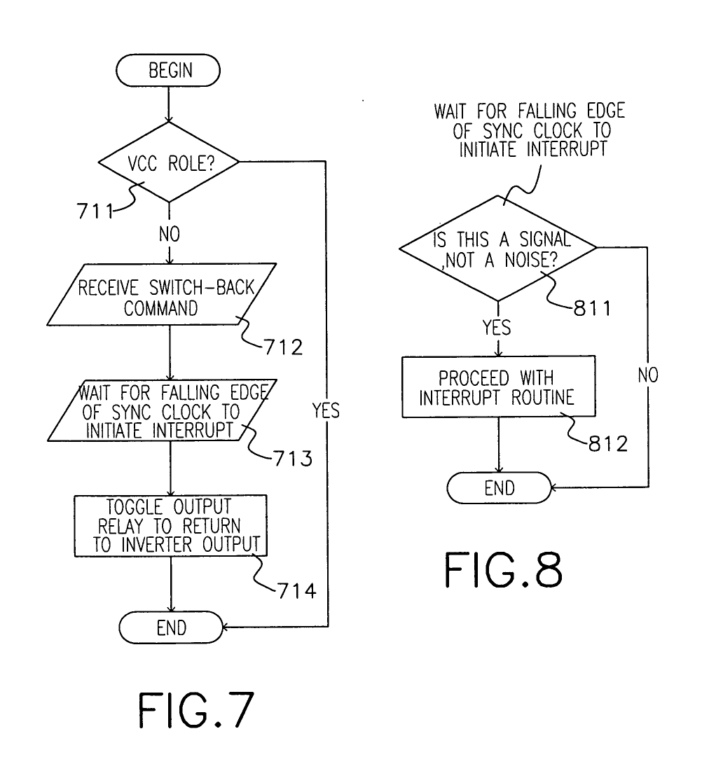

The above-mentioned operations are mainly used for switching UPS modules from the inverter mode to the bypass mode. Alternatively, the process can be reversed for switching the UPS modules from the bypass mode back to the inverter mode, to be explained by the following paragraphs in conjunction with FIGS. 6, 7.

When the VCC decides to put all parallel UPS modules (10) (101˜10n) back to the inverter mode from the previous bypass mode, the VCC collects the operation data from all UPS modules (10) (101˜10n) connected in parallel (613), from which the VCC determines whether all parallel UPS modules (10) (101˜10n) need to be switched back to the inverter mode (614). The basic criteria for the switch-back decision are that the total power required for the loads connected in the bypass mode is less than the total rated power of all parallel UPS modules, and that the output voltage of the inverter is restored to the normal condition.

When the VCC decides to switch back all parallel UPS modules (10) (101˜10n) in the modular power supply system to the inverter mode, the VCC also needs to select an appropriate timing to send out the switch-back command over the HSCL (615, 616). After all the UPS modules (10) (101˜10n) have received the switch-back command, all UPS modules (10) (101˜10n) wait for the falling edge of the sync clock (617) for initiating the system interrupt. After the UPS modules (10) (110˜10n) initiated the falling edge interrupt, the UPS modules (10) (101˜10n) send a toggle signal to the output relay (18) to return to the inverter mode (618). For the non-VCC modules (10) (101˜10n), the above procedures are simplified, as shown in FIG. 7, such that the UPS modules (10) (101˜10n) receiving the switch-back command only have to wait for the falling edge of the sync clock for initiating the interrupt (712, 713). After the interrupt occurs, the UPS modules (10) (101˜10n) send a toggle signal to the output relay (18) switch back to the inverter output (714).

The design of the modular power supply system in accordance with the present invention offers several advantages:

(1) The system does not need any additional hardware for implementing a fixed control unit, thus realizing cost saving for the system hardware and also improving the overall system reliability;

(2) Intelligent power management: the virtual control center first collects the operation data from all parallel UPS modules for determining whether to switch all parallel UPS modules to the bypass mode. For example, when one of the modules is down, and the system has unused power capacity, then it is only necessary to isolate the failing module so as not to affect other modules still supplying power to the load. For the conventional technique, the whole system has to be switched to the bypass mode all at one time. The modular power supply system in accordance with the present invention is thus more reliable and able to satisfy the power requirements of different loads with more flexibility;

(3) The output relay can be triggered by a lower order interrupt at the falling edge of the sync clock, knowing that there would be a discrepancy of a few microseconds for the inverter output when the relay is switched, and that the output would be able to allow for a few microseconds of parallel connection by the main-line and the inverter without damaging the system;

(4) The use of the embedded sync-clock-line in a parallel modular power supply system could avoid possible interference from other modules, thereby improving the reliability in synchronized switching;

(5) Use of lower order interrupt could prevent pausing of normal system operation and system resources which could otherwise be useful for monitoring the power supply status of other UPS modules; and

(6) Use of zero crossing for switching the output relay could protect the output relay from damage by electric arcing.

The foregoing description of the preferred embodiments of the present invention is intended to be illustrative only and, under no circumstances, should the scope of the present invention be so restricted.

What is claimed is:

1. A modular power supply system with fault bypass comprises a plurality of UPS modules connected in parallel, interconnected by a high speed communication line and the embedded sync-clock-line of the parallel AC power supply system, wherein each UPS module comprises:
an AC/DC converter being coupled to the main-line for converting the AC input to DC;
a DC bus being connected between the output of the AC/DC converter and the input to a DC/AC inverter;
a DC/AC inverter being coupled to the output of the AC/DC converter through the DC bus for converting DC power to AC output;
a DC/DC converter with the input coupled to the DC power input and the output connected to the DC bus; and
a controller coupled by the DC/AC inverter, AC/DC converter, and DC/DC converter for controlling the operation of the local UPS modules and other parallel UPS modules if elected VCC.

2. The modular power supply system with fault bypass as claimed in claim 1, wherein:
the input of each UPS module is connected to a common system input, and the output of each UPS module is connected to a common AC output bus; and
the output of the inverter in each UPS module is coupled with a bypass circuit, which is formed by a first-level relay and a second-level relay crossing over the input and output of the UPS module, where the first-level relay is used for switching the AC output between the inverter and the bypass, and the second level-relay is used for making or breaking the connection between the output of each UPS module and the AC output.

3. The modular power supply system with fault bypass as claimed in claim 2, wherein the first-level relay in the bypass circuit is implemented by a two-position relay.

4. The modular power supply system with fault bypass as claimed in claim 2, wherein the second-level relay in the bypass circuit is implemented by a single-position relay.

5. The modular power supply system with fault bypass as claimed in claim 2, wherein the first-level relay in the bypass circuit has an STS switch connected across the input and output.

6. The modular power supply system with fault bypass as claimed in claim 3 wherein the first-level relay in the bypass circuit has an STS switch connected across the input and output.

7. The modular power supply system with fault bypass as claimed in claim 2, wherein a shunt is provided between the system input and output with a manual bypass switch installed thereon.

8. The modular power supply system with fault bypass as claimed in claim 2, wherein each UPS module has a built-in controller with an independent processing capability and the ability to accept a role of virtual control center through an arbitration process over the high-speed communication line.
